(19) United States
(12) Patent Application Publication
(10) Pub. No.: US 2026/0267001 A1
(43) Pub. Date: Sep. 10, 2026

(54) DETECTION SYSTEM, DETECTION METHOD, AND WORK VEHICLE

(71) Applicant: KOMATSU LTD., Tokyo (JP)

(72) Inventor: Ryota Amano, Tokyo (JP)

(73) Assignee: KOMATSU LTD., Tokyo (JP)

(21) Appl. No.: 19/166,655

(22) PCT Filed: Apr. 23, 2024
(86) PCT No.: PCT/JP2024/015854

§ 371 Date: Sep. 18, 2025

(30) Foreign Application Priority Data
Apr. 26, 2023 (JP) 2023-072548

(51) Int. Cl. G01S 17/89; G01S 17/931

(52) U.S. Cl. CPC G01S 17/89; G01S 17/931

(57) ABSTRACT

A detection system includes: a three-dimensional sensor 11 that is attached to a work vehicle and detects an object that exists around the work vehicle; and a controller 20, that detects an obstacle and dust in a distinguished manner on a basis of object detection data from the three-dimensional sensor 11, object detection data from the three-dimensional sensor 11 includes a point cloud including a plurality of detection points defined on a surface of an object, and the controller 20 compares a number of detection points included in the object detection data with a determination threshold based on a point cloud density threshold defined by resolution of the three-dimensional sensor 11 for each grid obtained by dividing a detection range of the three-dimensional sensor 11, and detects an obstacle and dust in a distinguished manner.

### TECHNICAL FIELD

The present disclosure relates to a detection system, a detection method, and a work vehicle.

### BACKGROUND ART

In a work vehicle including an unmanned vehicle, a technique for determining whether an obstacle exists by an obstacle sensor is known (see, for example, Patent Literature 1).

### CITATION LIST

### Patent Literature

Patent Literature 1: JP 2023-042394 A

### SUMMARY OF INVENTION

### Technical Problem

A work vehicle operates at a work site where a lot of dust is generated, such as a mine or a construction site. In such a work site, there is a possibility that dust is detected as an obstacle. Therefore, detecting an obstacle and dust in a distinguished manner is desirable.

An object of an aspect of the present disclosure is to provide a detection system, a detection method, and a work vehicle capable of detecting an obstacle and dust in a distinguished manner.

### Solution to Problem

According to an aspect of the present disclosure, there is provided a detection system including: an object detection sensor that is attached to a work vehicle and detects an object that exists around the work vehicle; and a controller, in which the controller includes a detection unit that detects an obstacle and dust in a distinguished manner on a basis of object detection data from the object detection sensor, object detection data from the object detection sensor includes a point cloud including a plurality of detection points defined on a surface of an object, and the detection unit compares a number of detection points included in the object detection data with a determination threshold based on a point cloud density threshold defined by resolution of the object detection sensor for each grid obtained by dividing a detection range of the object detection sensor, and detects an obstacle and dust in a distinguished manner.

According to an aspect of the present disclosure, there is provided a detection method including: an object detection sensor that is attached to a work vehicle and detects an object that exists around the work vehicle; and a controller, in which object detection data including a point cloud including a plurality of detection points defined on a surface of an object is acquired from the object detection sensor, and a number of detection points included in the object detection data is compared with a determination threshold based on a point cloud density threshold defined by resolution of the object detection sensor for each grid obtained by dividing a detection range of the object detection sensor, and an obstacle and dust are detected in a distinguished manner.

According to an aspect of the present disclosure, a work vehicle including the detection system and a vehicle body is provided.

### Advantageous Effects of Invention

According to an aspect of the present disclosure, a detection system, a detection method, and a work vehicle capable of detecting an obstacle and dust in a distinguished manner are provided.

### BRIEF DESCRIPTION OF DRAWINGS

FIG. 1 is a perspective view of a work vehicle according to an embodiment as viewed from an obliquely upper left front side.

FIG. 2 is a functional block diagram illustrating a detection system according to the embodiment.

FIG. 3 is a block diagram illustrating a computer system according to the embodiment.

FIG. 4 is a schematic diagram illustrating an example of detection points of objects by a three-dimensional sensor.

FIG. 5 is a schematic diagram illustrating an example of detection points of objects by the three-dimensional sensor and grids.

FIG. 6 is a schematic diagram for describing resolution of the three-dimensional sensor.

FIG. 7 is a schematic diagram illustrating an example of object detection.

FIG. 8 is a flowchart illustrating a detection method of the detection system according to the embodiment.

### DESCRIPTION OF EMBODIMENTS

Hereinafter, embodiments according to the present disclosure will be described with reference to the drawings, but the present disclosure is not limited thereto. The components of the embodiments described below can be appropriately combined. Furthermore, some components may not be used.

### Work Vehicle

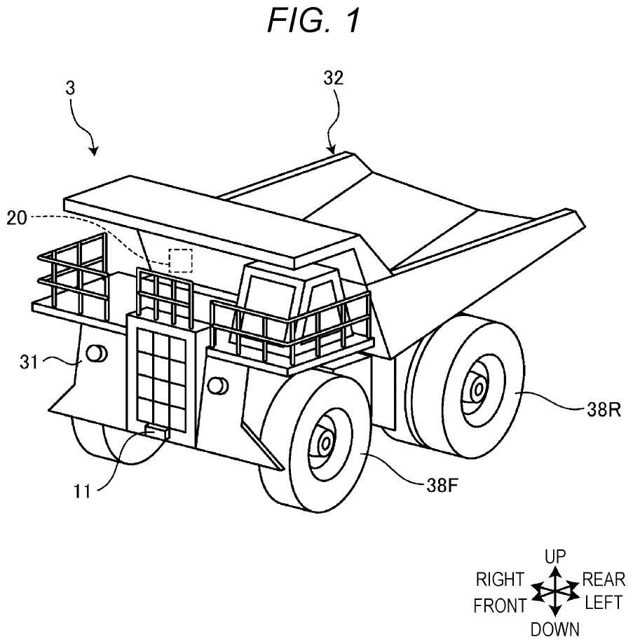

FIG. 1 is a perspective view of a transporter vehicle, which is an example of a work vehicle according to an embodiment, as viewed from an obliquely upper left front side. A work vehicle 3 is a vehicle that operates at a work site. In the embodiment, a transporter vehicle, which is an example of the work vehicle, will be described. The transporter vehicle 3 is, for example, a dump truck that transports a load at a work site such as a mine. The transporter vehicle 3 detects obstacles and dust that exist around the transporter vehicle 3 in a distinguished manner. The transporter vehicle 3 may be a manned dump truck operated by a driving operation of a driver, or may be an unmanned dump truck operated in an unmanned manner. The transporter vehicle 3 includes a vehicle body 31, a vessel 32 supported by the vehicle body 31, a pair of left and right front wheels 38F, and a pair of left and right rear wheels 38R.

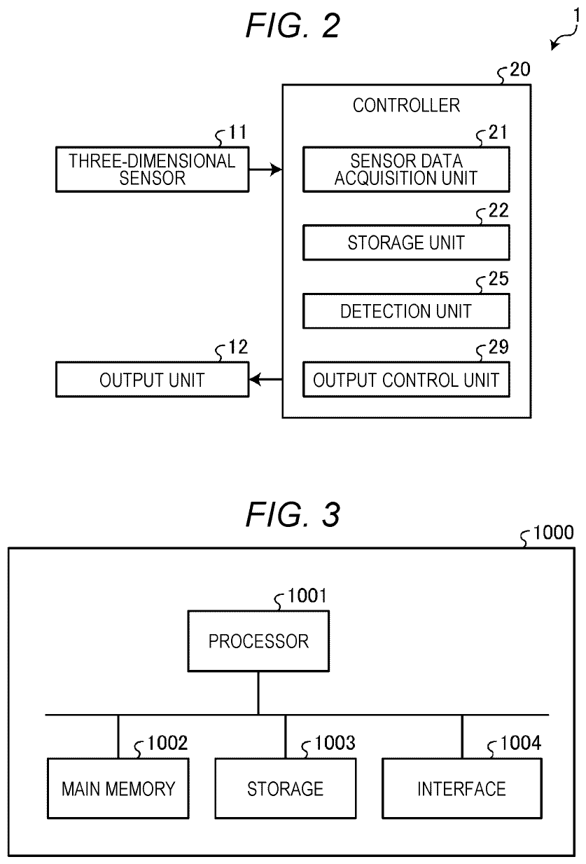

FIG. 2 is a functional block diagram illustrating a detection system according to the embodiment. The detection system 1 of the transporter vehicle 3 includes a three-dimensional sensor (object detection sensor) 11, an output unit 12, and a controller 20. The three-dimensional sensor 11 and the controller 20 are connected such that data can be communicated wirelessly or by wire.

The three-dimensional sensor 11 is attached to the transporter vehicle 3. In the embodiment, the three-dimensional sensor 11 is attached to the front portion of the transporter vehicle 3. The number of the three-dimensional sensors 11 is not particularly limited to any number, and for example, two three-dimensional sensors 11 may be disposed on the transporter vehicle 3. The three-dimensional sensor 11 is an object detection sensor that detects an object that exists around the transporter vehicle 3. In the embodiment, the three-dimensional sensor 11 is an object detection sensor that detects an object that exists in front of the transporter vehicle 3. The three-dimensional sensor 11 can detect, for example, a range of about several 10 [m]. The three-dimensional sensor 11 transmits detected object detection data to the controller 20.

The three-dimensional sensor 11 acquires three-dimensional data of an object. The three-dimensional data of an object includes a point cloud including a plurality of detection points defined on the surface of the object. The point cloud indicates a relative distance and a relative position between the three-dimensional sensor 11 and each of a plurality of detection points defined on the surface of the object. Examples of the three-dimensional sensor 11 include a laser sensor (light detection and ranging [LiDAR] ) that detects an object by emitting laser light. Note that the three-dimensional sensor 11 may be another non-contact sensor such as an infrared sensor that detects an object by emitting infrared light or a radar sensor (radio detection and ranging [RADAR] ) that detects an object by emitting radio waves.

The output unit 12 outputs a determination result by a detection unit 25 from the output unit 12. The output unit 12 is, for example, a lamp, a buzzer, or the like. The output unit 12 is output under the control of an output control unit 29.

### Control System (Controller) of Transporter Vehicle

The controller 20 detects obstacles and dust around the transporter vehicle 3 in a distinguished manner. The controller 20 can acquire object detection data from the three-dimensional sensor 11 as an object detection sensor. The controller 20 includes a numerical operation device (processor) such as a central processing unit (CPU).

FIG. 3 is a block diagram illustrating a computer system according to the embodiment. The controller 20 includes a computer system 1000. The computer system 1000 includes a processor 1001 such as a CPU, a main memory 1002 including a nonvolatile memory such as a read only memory (ROM) and a volatile memory such as a random access memory (RAM), a storage 1003, and an interface 1004 including an input/output circuit. The above-described function of the controller 20 is stored in the storage 1003 as a program. The processor 1001 reads the program from the storage 1003, develops the program in the main memory 1002, and executes the above processing according to the program. Note that the program may be distributed to the computer system 1000 via a network.

In the embodiment, the controller 20 includes a sensor data acquisition unit 21, a storage unit 22, the detection unit 25, and the output control unit 29.

The sensor data acquisition unit 21 acquires object detection data from the three-dimensional sensor 11. The object detection data acquired by the sensor data acquisition unit 21 is, for example, a point cloud including a plurality of detection points.

The storage unit 22 includes at least one of a RAM, a ROM, a flash memory, or a hard disk drive. The storage unit 22 stores data and the like used in processing of the controller 20.

The storage unit 22 stores the resolution of the three-dimensional sensor 11 in advance. In the embodiment, the storage unit 22 stores the resolution in the up-down direction of the three-dimensional sensor 11 in advance.

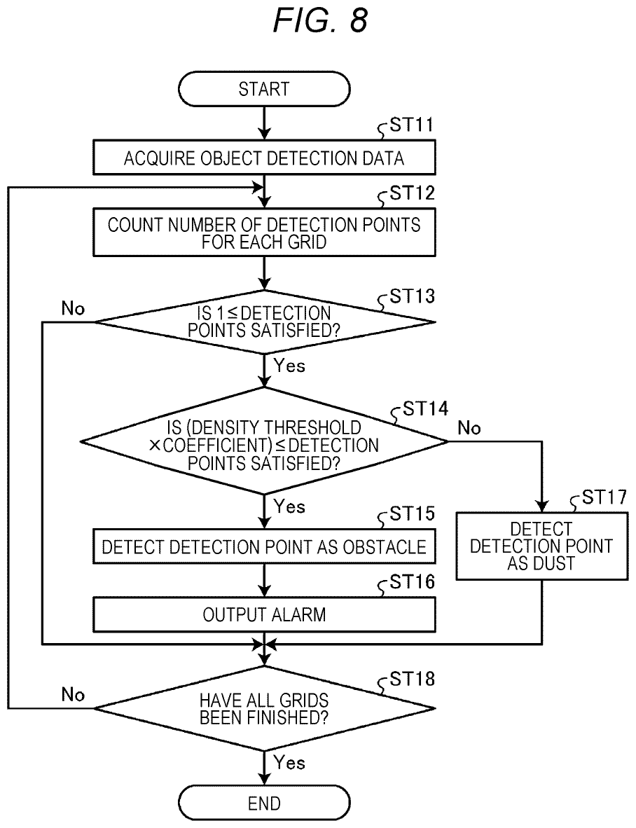

The storage unit 22 stores a point cloud density threshold (hereinafter, referred to as “density threshold”) in advance. The density threshold is stored before processing of the flowchart illustrated in FIG. 8 to be described below is executed. The density threshold will be described below.

The detection unit 25 detects an obstacle and dust in a distinguished manner on the basis of object detection data from the three-dimensional sensor 11 as an object detection sensor. More specifically, the detection unit 25 counts the number of detection points for each grid from the object detection data. The detection unit 25 determines whether the number of detection points is equal to or larger than a determination threshold obtained by multiplying the density threshold by a coefficient. If it is determined that the number of detection points is equal to or larger than the determination threshold obtained by multiplying the density threshold by a coefficient, the detection unit 25 detects the detection point as an obstacle. If it is not determined that the number of detection points is equal to or larger than the determination threshold obtained by multiplying the density threshold by a coefficient, the controller 20 detects the detection point as dust.

The detection unit 25 counts the number of detection points at a predetermined height or higher from the ground for each grid from the object detection data. This is to remove a detection point at which the ground is detected.

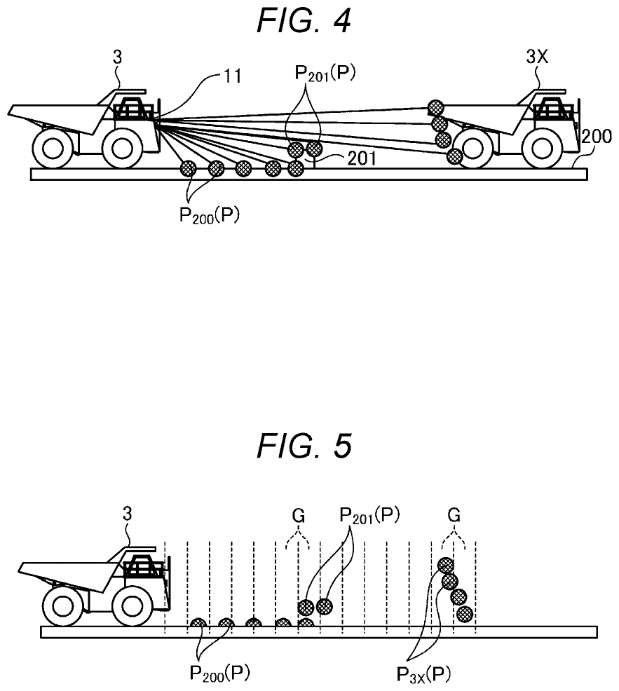

FIG. 4 is a schematic diagram illustrating an example of detection points of objects by a three-dimensional sensor. FIG. 4 illustrates a state in which the three-dimensional sensor 11 mounted on the transporter vehicle 3 detects a ground 200 in front, a convex portion 201 of the ground 200, and a transporter vehicle 3X in front. Detection points P at which the ground 200 in front is detected are denoted by P₂₀₀, detection points P at which the convex portion 201 is detected are denoted by P₂₀₁, and detection points P at which the transporter vehicle 3X in front is detected are denoted by P_{3X}.

FIG. 5 is a schematic diagram illustrating an example of detection points of objects by the three-dimensional sensor and grids. FIG. 5 illustrates a state in which the detection range of the three-dimensional sensor 11 mounted on the transporter vehicle 3 is divided into a plurality of grids G. The grids G are formed by dividing the detection range of the three-dimensional sensor 11 into a lattice shape in the left-right direction and the front-rear direction as viewed in the up-down direction. The grids G are formed in a quadrangular prism shape. The lengths of the grids G in the left-right direction and the front-rear direction as viewed in the up-down direction are not limited to any lengths.

FIG. 6 is a schematic diagram for describing resolution of the three-dimensional sensor. For each of the grids G, a distance D between a vertical center line CL passing through the center point of the grid G as viewed in the up-down direction and the three-dimensional sensor 11 is calculated. The resolution in the up-down direction of the three-dimensional sensor 11 is stored in the storage unit 22 in advance. In a case where an object is detected by the three-dimensional sensor 11, a point cloud including a plurality of detection points defined on the surface of the object is obtained. Note that, in a case where there is no object in the grid G, a point cloud other than a point cloud at which the ground is detected is not obtained. From the height from the ground at which the point cloud is obtained and the resolution, the density threshold defined by the number of detection points obtained in a case where the laser strikes an object located at the height is calculated. As in the following Formula (1), a determination threshold obtained by multiplying the density threshold by a coefficient is used as a determination threshold in the detection unit 25. The coefficient is set, for example, for each work site.

$$Determination threshold = density threshold \times coefficient \qquad ( 1 )$$

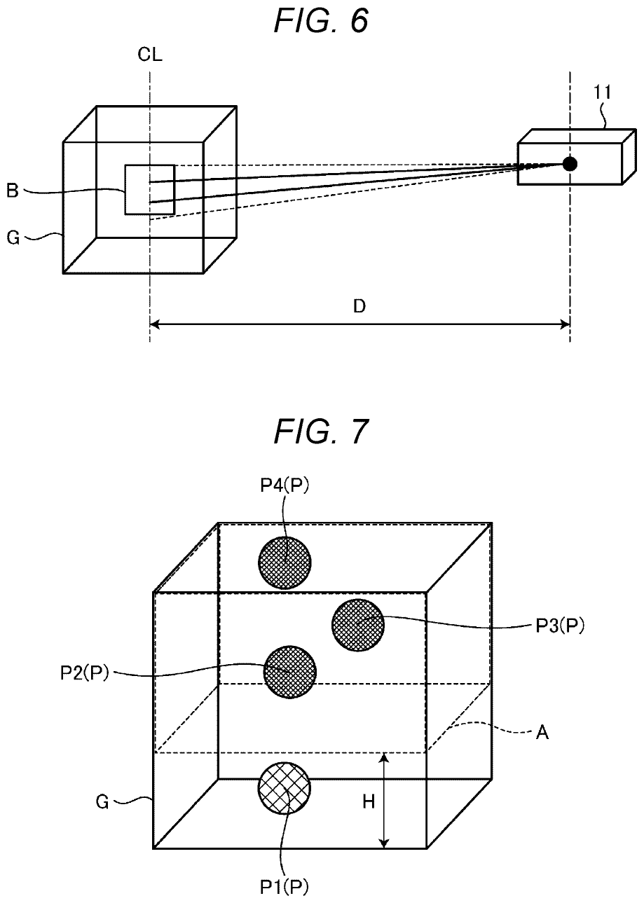

FIG. 7 is a schematic diagram illustrating an example of object detection. In the grid G, detection points P included in a region A at a height of H or higher from the ground are counted. The region A at a height of H or higher from the ground is set in order to exclude detection points P at which the ground is detected. The detection point P1 is not included in the region A. Three points of a detection point P2, a detection point P3, and a detection point P4 are included in the region A. In a case where the determination threshold that is the density threshold×the coefficient calculated by Formula 1 is, for example, “3” and the number of detection points is “3”, it is determined that the object is an obstacle. In a case where the determination threshold that is the density threshold×the coefficient calculated by Formula 1 is, for example, “4” and the number of detection points is “3”, it is determined that the object is obstacle dust.

The output control unit 29 performs control such that a detection result by the detection unit 25 is output via the output unit 12. For example, the output control unit 29 outputs a control signal for turning on the lamp in different modes in a case where an obstacle is detected and in a case where dust is detected. For example, the output control unit 29 outputs a control signal for sounding the buzzer in different modes in a case where an obstacle is detected and in a case where dust is detected.

### Basic Processing

A detection method of the detection system 1 will be described with reference to FIG. 8. FIG. 8 is a flowchart illustrating a detection method of the detection system according to the embodiment. During operation of the transporter vehicle 3, the detection system 1 is activated. During the activation of the detection system 1, the processing of the flowchart illustrated in FIG. 8 is executed. During the activation of the detection system 1, the three-dimensional sensor 11 detects an object.

The controller 20 acquires object detection data (step ST11). More specifically, the controller 20 acquires the object detection data from the three-dimensional sensor 11 by the sensor data acquisition unit 21. The controller 20 proceeds to step ST12.

The controller 20 counts the number of detection points for each grid (step ST12). More specifically, the controller 20 counts the number of detection points that is the number of detection points at a height of H or higher from the ground among detection points for each grid from the object detection data by the detection unit 25. The controller 20 proceeds to step ST13.

The controller 20 determines whether the number of detection points for each grid is one or more (step ST13). More specifically, if the detection unit 25 determines that the number of detection points for each grid is one or more (Yes in step ST13), the controller 20 proceeds to step ST14. In this case, the grid includes detection points.

If the detection unit 25 does not determine that the number of detection points for each grid is one or more (No in step ST13), the controller 20 proceeds to step ST18. In this case, the grid does not include detection points.

If it is determined that the number of detection points for each grid is one or more (Yes in step ST13), the controller 20 determines whether the number of detection points is equal to or larger than the determination threshold obtained by multiplying the density threshold by a coefficient (step ST14). More specifically, if it is determined that the number of detection points is equal to or larger than the determination threshold obtained by multiplying the density threshold by a coefficient (Yes in step ST14), the controller 20 proceeds to step ST15. If it is not determined that the number of detection points is equal to or larger than the determination threshold obtained by multiplying the density threshold by a coefficient (No in step ST14), the controller 20 proceeds to step ST17.

If it is determined that the number of detection points is equal to or larger than the determination threshold obtained by multiplying the density threshold by a coefficient (Yes in step ST14), the controller 20 detects a detection point of the grid as an obstacle (step ST15). The controller 20 proceeds to step ST16.

The controller 20 outputs an alarm (step ST16). More specifically, the controller 20 performs control such that the output control unit 29 outputs an alarm indicating that an obstacle has been detected via the output unit 12. The controller 20 proceeds to step ST18.

If it is not determined that the number of detection points is equal to or larger than the determination threshold obtained by multiplying the density threshold by a coefficient (No in step ST14), the controller 20 detects a detection point of the grid as dust (step ST17). The controller 20 proceeds to step ST18.

The controller 20 determines whether all grids have been finished (step ST18). If it is not determined that all the grids have been finished (No in step ST18), the controller 20 executes the processing of step ST12 again. If it is determined that all the grids have been finished (Yes in step ST18), the controller 20 ends the processing of this flowchart.

### Effects

As described above, in the embodiment, for each grid obtained by dividing the detection range of the three-dimensional sensor 11, the number of detection points included in object detection data is compared with the determination threshold based on the point cloud density threshold defined by the resolution of the three-dimensional sensor 11, and an obstacle and dust are detected in a distinguished manner. As described above, according to the embodiment, an obstacle and dust can be detected in a distinguished manner.

In the embodiment, if the number of detection points is equal to or larger than the determination threshold, the detection point is detected as an obstacle. According to the embodiment, an obstacle can be appropriately detected.

In the embodiment, if the number of detection points is smaller than the determination threshold, the detection point is detected as dust. The embodiment can appropriately detect dust. According to the embodiment, erroneous detection of dust as an obstacle can be reduced.

In the embodiment, the number of detection points at a predetermined height or higher from the ground is compared with the determination threshold based on the point cloud density threshold defined by the resolution of the three-dimensional sensor 11. According to the embodiment, erroneous detection of the ground as an obstacle can be reduced.

In the embodiment, the determination threshold is calculated by multiplying the point cloud density threshold by a coefficient. According to the embodiment, an appropriate determination threshold can be set according to a work site or the like.

In the above description, it has been described that the grids have a lattice shape, but the present disclosure is not limited thereto. For example, the grids may be divided into another shape such as a stripe shape.

In the embodiment, the work vehicle 3 is a dump truck, but the present disclosure is not limited thereto. For example, the work vehicle 3 according to another embodiment may be another work vehicle such as an excavator, a bulldozer, or a wheel loader.

### REFERENCE SIGNS LIST

1 Detection system
3 Transporter vehicle (work vehicle)
31 Vehicle body
32 Vessel
38F Front wheel
38R Rear wheel
11 Three-dimensional sensor (object detection sensor)
12 Output unit
20 Controller
21 Sensor data acquisition unit
22 Storage unit
25 Detection unit
29 Output control unit.

1. A detection system comprising:
an object detection sensor that is attached to a work vehicle and detects an object that exists around the work vehicle; and
a controller,
that detects an obstacle and dust in a distinguished manner on a basis of object detection data from the object detection sensor,
object detection data from the object detection sensor includes a point cloud including a plurality of detection points defined on a surface of an object, and
the controller compares a number of detection points included in the object detection data with a determination threshold based on a point cloud density threshold defined by resolution of the object detection sensor for each grid obtained by dividing a detection range of the object detection sensor, and detects an obstacle and dust in a distinguished manner.

2. The detection system according to claim 1, wherein
the controller detects a detection point as an obstacle in a case where a number of the detection points is equal to or larger than the determination threshold.

3. The detection system according to claim 1, wherein
the controller detects a detection point as dust in a case where a number of the detection points is smaller than the determination threshold.

4. The detection system according to claim 1, wherein
the controller compares a number of the detection points at a predetermined height or higher from a ground with a determination threshold based on a point cloud density threshold defined by resolution of the object detection sensor.

5. The detection system according to claim 1, wherein
the determination threshold is calculated by multiplying the point cloud density threshold by a coefficient.

6. A detection method comprising:
an object detection sensor that is attached to a work vehicle and detects an object that exists around the work vehicle; and
a controller, wherein
object detection data including a point cloud including a plurality of detection points defined on a surface of an object is acquired from the object detection sensor, and
a number of detection points included in the object detection data is compared with a determination threshold based on a point cloud density threshold defined by resolution of the object detection sensor for each grid obtained by dividing a detection range of the object detection sensor, and an obstacle and dust are detected in a distinguished manner.

7. A work vehicle comprising:
the detection system according to claim 1; and
a vehicle body.
